(19) United States
(12) Patent Application Publication
(10) Pub. No.: US 2025/0315314 A1
(43) Pub. Date: Oct. 9, 2025

(54) WORKLOADS AS A SERVICE AND DISCOVERY THEREOF

(71) Applicant: Microsoft Technology Licensing, LLC, Redmond, WA (US)

(72) Inventors: Mukesh KUMAR, Hyderabad (IN); Praveen KUMAR R, Hyderabad (IN); Amit GANGULI, Hyderabad (IN); Naveen Kumar KURMADAS, Hyderabad (IN)

(21) Appl. No.: 18/631,028

(22) Filed: Apr. 9, 2024

(51) Int. Cl. G06F 9/50

(52) U.S. Cl. CPC G06F 9/5072; G06F 9/5033

(57) ABSTRACT

Described herein are technologies for automating discovery of a workload deployment, including its components and infrastructure resource dependencies to enable management of complex workloads as a single abstraction. Workload application identification information is identified from a first compute resource hosting a main component of the workload deployment, and a set of automations specific to that workload application identification information is accessed. The set of automations identify all workload components and infrastructure resources on which each of the workload components depend. This data, including relationship data such as dependencies, is compiled into a data structure, that serves as a reference for a workload abstraction. When a management operation is applied to the workload abstraction, the management layer redirects the operation to each of the components or infrastructure resources associated with the workload deployment.

### BACKGROUND

The term, “workload” refers to a set of computational tasks or services running on or in conjunction with a set of physical and/or virtual compute, networking, and storage (“infrastructure”) resources. Examples can include simple multitier web applications and complex enterprise class database and business intelligence software. Certain workloads can provide important or even mission-critical functionality to enterprises. Examples include SAP or Oracle business management and technology platform software and Epic Systems healthcare software workloads. These are very complex workloads, and over the years of software and hardware upgrades and migrations, deployments of these workloads can lose fidelity to best practices, in terms of maintaining all components in a distinct set of dedicated subnets in physical proximity to one another, maintaining distinct data storage resources, and ensuring appropriate infrastructure resources are reserved and/or available for the respective components. Furthermore, such highly complex workloads include many software components that can sprawl across a large number of physical resources to the point where administrators can lose track of where all the components reside and in fact what set of physical resources are relied upon by a particular workload. This makes management of such complex workloads unwieldy and prone to error.

### SUMMARY

Described herein are technologies for discovering complex workloads in a variety of environments. These technologies include methods, machine readable instructions encoded onto at least one computer storage medium for performing the methods, and systems including at least one computer processor executing such instructions. The methods comprise a set of operations, including: an operation for obtaining workload application identification information for a workload deployed in an infrastructure, an operation for querying a workload database using the workload application identification information to obtain a set of automations specific to the workload application identification information, an operation for executing automations to obtain workload component and dependent infrastructure resource metadata, an operation for compiling the workload component the dependent infrastructure resource metadata into a data structure, an operation for generating a workload abstraction corresponding to the data structure; and an operation for applying a management operation to the workload abstraction.

### BRIEF DESCRIPTION OF THE DRAWINGS

The present description will be better understood from the following detailed description, which refers to the accompanying drawings, wherein:

FIG. 1 shows an environment for discovering a workload deployment and its dependencies.

FIG. 2 shows a flowchart illustrating a first example process for discovering a workload deployment.

FIG. 3 shows a flowchart illustrating a second example process for discovering a workload deployment.

FIG. 4 shows a high-level block view of a workload graph.

FIG. 5 is a functional block diagram illustrating by way of example a computing apparatus with which the technology described by the present disclosure is operable.

### DETAILED DESCRIPTION

The presently described technology addresses at least the technical problem of automating discovery of a workload deployment, including all its components and infrastructure resource dependencies, so that such complex workloads can each be managed as a single abstraction. The methods presented herein are agnostic as to the type of infrastructure in which the workload is deployed, whether directly on physical infrastructure or on virtualized infrastructure, and whether the workload deployment is on-premises (i.e., within a private datacenter) or cloud-hosted.

Workloads may be deployed on premises directly on physical computers (“physical compute resources” or “hosts”) or in virtual machines (also referred to as “virtual compute resources”). One or more virtual machines can run on a single physical host. Workloads may also be deployed as a set of containerized services. A containerized service is an application-level abstraction in which a particular service application and all of its dependencies are packaged into a single container file which can be then deployed, along with other isolated instances of other containers on a single operating system instance in a single computer or virtual machine. Because all of the dependencies are included within the container, the containerized service can be expected to reliably execute as intended.

Workloads may also be deployed in public cloud-based infrastructures such as MICROSOFT AUZURE™, AMAZON AWS™, or GOOGLE CLOUD PLATFROM™ (GCP). Such public cloud services can host workload components on virtual machines, in containers, or even serverless functions or a combination thereof.

Workloads maintain information about logical locations of their components, wherein such logical locations can be expressed as internet protocol (IP) addresses, logical unit numbers (LUNs) of storage resources, etc. However, correlating this information to actual physical machines, network connections (and appropriate configurations of security zones and/or firewall rules that allow these network connections) as well as physical storage resources, requires additional information from administrative tools such as virtual resource management software which maintains relationship information between logical addresses and physical resources. This relationship data includes which IP address corresponds to which virtual machine, and which virtual machine resides on which host. However, the resource manager may not know which virtual machines are running components of a particular workload.

As a result of different workloads maintaining component association information in different forms (e.g., different file formats) and in different locations, and because workloads may reside on a variety of different types of physical infrastructure, there is no generic mechanism to discover all the components of a workload, or all the physical resource dependencies thereof. Without accurate and reliable information of where all the workload components reside, it is difficult if not impossible to correctly perform basic management functions for the workload as a whole. Such management functions can include workload health monitoring, workload backup/migration, applying appropriate security policies to workloads, or workload disaster recovery.

Described herein are a set of technologies including methods, systems, and computer instructions (code) encoded into a computer readable storage media for addressing the challenges noted above. The proposed technologies perform a set of operations using a variety of technologies to identify the location of every component of the workload, and the set of virtual and/or physical resources upon which each of those components rely. This deployment-specific information is compiled into a data structure. A management plane for the infrastructure can then expose the workload deployment as a whole in the form of a workload deployment abstraction, which may be represented as an icon on a graphical user interface produced by the management plane. The management component can then receive instructions from an administrator or other user to perform a management operation on the workload as a whole, and these instructions may be redirected to the individual components of the workload based on the information in the data structure.

Exemplary operations for identifying the location of every component of the workload, and the set of virtual and/or physical resources upon which each of those components rely include (1) obtaining workload application identification information for a workload deployed in an infrastructure, the infrastructure comprising infrastructure resources including compute, networking, and storage infrastructure resources, the workload deployment comprising a plurality of workload components deployed across a plurality of the compute infrastructure resources, the workload application identification information comprising a workload application name and version reference associated with the workload deployment; (2) querying a workload database using the workload application identification information; (3) in response to the querying, obtaining a set of automations for discovering workload component and dependent infrastructure resource metadata corresponding to or associated with all of the workload components of the workload deployment, the set of automations comprising at least one automation comprising executable code; (4) executing the set of automations obtained from the workload database; (5) obtaining, from the set of automations, the workload component and the dependent infrastructure resource metadata for all of the workload components, the metadata including, for each of the workload components, relationship information and compute resource identity information, the relationship information providing dependency information between workloads, and the compute resource identity information identifiers of compute infrastructure resources upon which the workload components execute; (6) compiling the workload component and the dependent infrastructure resource metadata for the workload deployment into a data structure; (7) generating a workload abstraction corresponding to the data structure; and (8) performing a management operation using the workload abstraction.

These operations provide technical effects including improved infrastructure resource efficiency, simplified management of workloads, enhanced security and reliability, reduced error rate, simplified data center resource allocation and management, improved usability for systems and application administrators, improved user efficiency, and simplified representation of machine states. These advantages are further explained in detail below but at a high level, the technologies described herein permit an administrator or other user to interact with a single representation of a workload, referred to herein as a workload abstraction. The workload abstraction may be treated as a unitary object by the administrator/user for the purpose of performing any of a variety of management operations. The management plane can automate the redirection of these management operations to each of the workload components and the infrastructure resources on which they depend for simplified interactions and concomitant reduced error as compared to performing management operations on each component individually, which is the current practice. These simplified interactions include simplified data center resource allocation and management since management operations (such as monitor, backup, migrate, etc.) performed on the workload abstraction will often directly depend on or impact data center resource allocation of, e.g., compute resources to workload components. Resource efficiency, security, reliability, etc. are enhanced due to the reduced error rate, and in addition by encoding “best practices” into the workload abstraction, these best practices can be automatically adhered to when performing certain management operations such as migrate, backup/restore, disaster recovery, etc. A unified health score can be determined as explained below using the workload abstraction in which the health score combines health scores of individual workload components thereby providing a simplified representation of machine state.

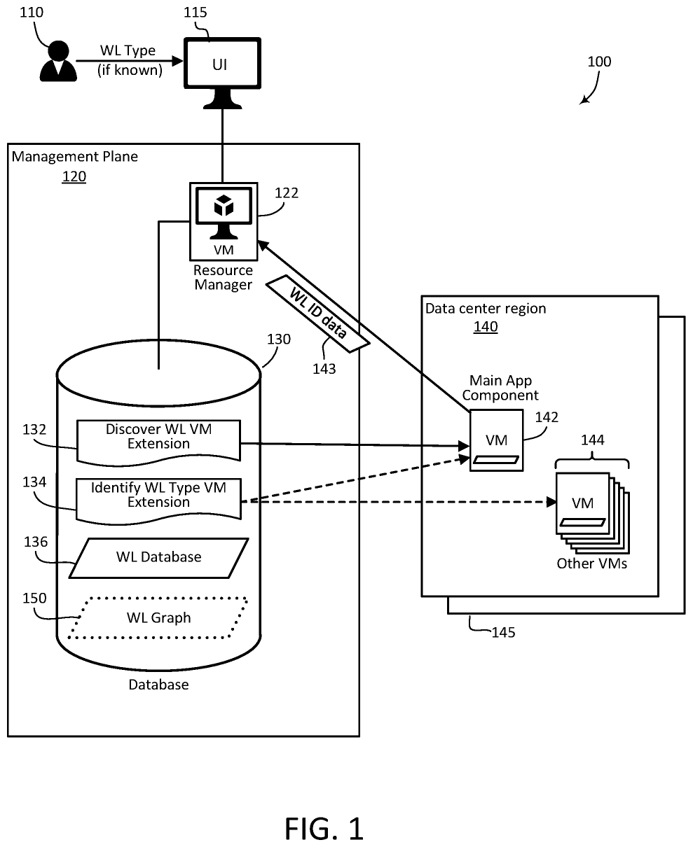

FIG. 1 shows environment 100 for discovering a workload deployment and its dependencies. Management plane 120 includes resource manager 122, which is software for managing resources in datacenter region 140. For example, resource manager 122 can deploy new virtual machines (VMs), for example, the VMs 142 and 144, migrate VMs 142 and 144 from one host to another, and remove (e.g., delete) the VMs 142 and 144 from the datacenter region 140. Resource manager 122 may also provide a user interface 115, e.g., via a web browser, through which a user 110 interacts with VMs 142 and 144. Such a user interface, along with controls for managing VM lifecycle and configurations, present a remote console view of a command line interface or desktop environment generated by a target VM in the datacenter region 140.

The management plane 120 also includes data storage 130, which may represent a set of data storage resources such as SAN or other resources accessible to the resource manager 122. The data storage 130 includes several resources including discover workload type extension 132, identify workload type extension 134, workload database 136, and workload (WL) graph 150. VM extensions (VMEs) (e.g., the discover workload type extension 132 and the identify workload type extension 134) are scripts or other executable code that can be pushed by the management plane 120 to a target VM and executed with the assistance of preinstalled agents on VMs 142 and 144 for the purpose of performing VM introspection. The VMEs (e.g., the discover workload type extension 132 and the identify workload type extension 134) are also considered agents since they operate on behalf of the workload deployment discovery processes.

In some examples, other methods of pushing extensions to the target VM are used. For example, a “pull” mechanism in which a process on each VM may periodically poll a repository for updated configuration information which can then instruct the VM to pull new code from the same or a different repository for execution. Another option is to employ a REST API (i.e., a representational state transfer application programming interface) to perform VM introspection. In any case, management plane 120 ensures that the VME is digitally signed by trusted publishers to ensure authenticity and integrity of the extension before it can run on the target VM. Furthermore, while the examples described here are suitable where the datacenter region 140 employes VMs for executing software the same types of mechanisms can be implemented for other types of infrastructure including physical and containerized. An example of a container orchestration platform is KUBERNETES™, an open source project maintained by the Cloud Native Computing Foundation.

With continued reference to FIG. 1, the identify workload type extension 134 is installed on all VMs (e.g., the VMs 142 and 144) of a particular user's subscription to identify VMs hosting any workload applications and their main components. The discover workload type extension 132 can be installed on a target VM to obtain workload application identification data. This data includes details about the workload software including application product name and version number (or more broadly, “version reference” which could be a number or some other designation indicating a particular release of the workload).

Workload database 136 includes architectural information for different software products and releases and automations for discovering environment and dependency information for the different components within the software products. Each automation can be a script such as PYTHON™ or BASH™ scripts, or other code for execution locally or within target infrastructure being discovered. Scripts can be used to access APIs or secure shell (SSH) interfaces exported by various components including host computing systems, virtualized infrastructure such as VMs and containers, and network and storage devices.

Workload graph (“WL Graph”) 150 is a data structure that encodes data that represents relating all workload components and infrastructure dependencies. This data can include component identifiers, identifiers for compute and networking infrastructure resources where the component is executed. Characteristics of the compute resources may additionally be maintained by workload graph 150 and may include various properties of the compute resources such as the amount of memory and the number, type, and clock speed of the processor resources of the compute component. Additional information about the networking resources can include the domain, subnet, security zone or other network abstraction information, policies, and available or consumed bandwidth. Storage data can include, for each workload component, what data storage resources are accessed and where that data storage resides physically (locally on the compute platform, or via network connections) and/or logically (e.g., a network address).

While the management plane 120 is shown separate from datacenter region 140 in FIG. 1, in some examples, the management plane 120 resides within the datacenter region 140. The management plane 120 may alternatively reside on premises, i.e., within a private data center, in some third location such as another datacenter region, or be provided “as a service” by a cloud provider.

Furthermore, while FIG. 1 illustrates the resource manager 122 exclusively managing VMs within a single datacenter region (e.g., the datacenter region 140), in some examples, environments are managed in one or more additional datacenter regions 145. In addition, while the resource manager 122 is illustrated as a single VM, in some examples the resource manager 122 is a cluster of VMs for scalability and redundancy, or be distributed across VMs within the datacenter regions 140 and/or 145. In other examples, the resource manager 122 is implemented using scalable microservices architecture or other application architecture.

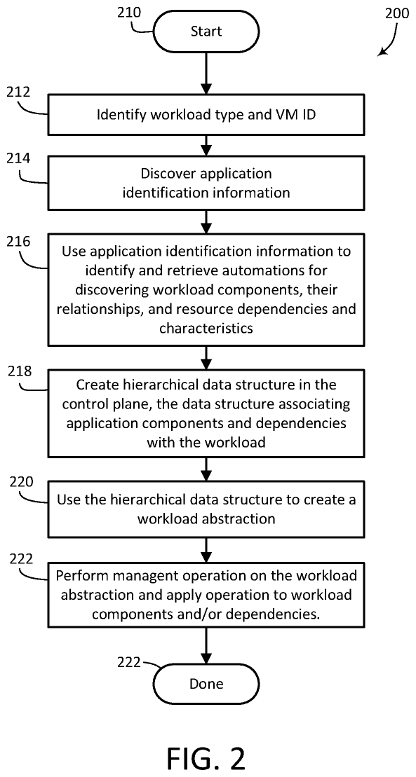

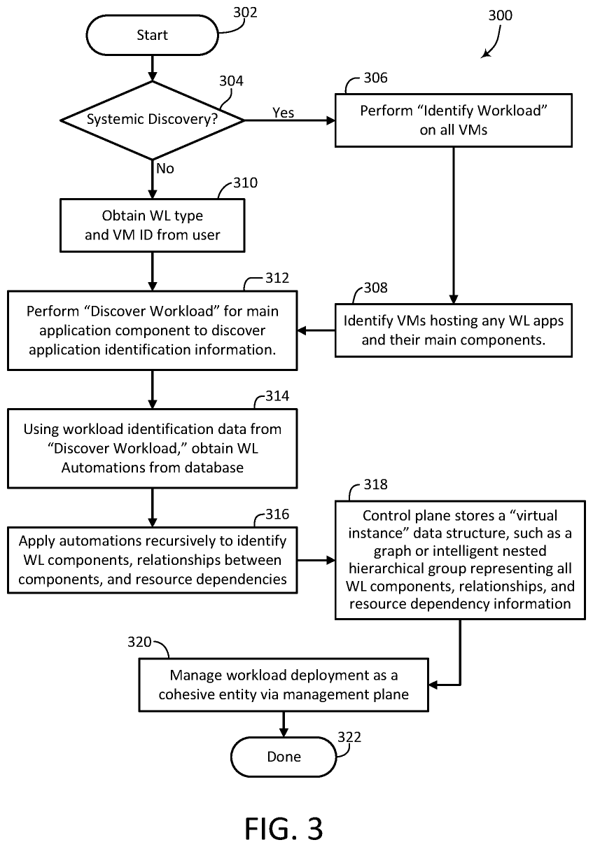

As described herein, the resource manager 122 performs methods with reference to FIGS. 2 and 3 for discovering a workload deployment so that it can be managed as a single entity. However, it should be recognized that it is also possible for a process that is separate from the resource manager 122 to perform these methods. For example, a dedicated “Workload as a Service Discovery Application” (not shown) can be invoked by the resource manager 122, or directly by the user 110 by some other automation (not shown) which can perform the herein described methods. Such an application can be given necessary privileges to perform the operation and reside within the datacenter regions 140 and/or 145, within the management plane 120, or elsewhere.

FIG. 2 presents a flowchart 200 illustrating an example process for discovering a deployed workload. As explained above, this process is performed by the resource manager 122 in some examples or some other component of the management plane 120, or some stand-alone application in other examples. The process illustrated in FIG. 2 can be implemented using machine readable and executable instructions stored on some non-transitory data storage medium or media using one or more computer processors (not shown).

The process begins at start block 210 and proceeds with operation 212 in which a workload type and VM identifier (“VM ID”) is identified. In one example, the workload type is an indication of a software vendor such as ORACLE™ or SAP™. The VM identifier is a globally unique identifier (GUID) of the VM 142, which runs the main application component of the workload being discovered. The VM identifier can also be mapped by the management plane 120 to other information about the VM 142, such as what software is installed on the VM 142, who has permissions to access and/or modify the VM 142, etc., and various other configuration information, including network address information.

While the control plane may maintain some information as to the software installed on the VM 142, the control plane does not typically have specific workload application identity information that includes an application identifier such as an application name, and a version number for the workload. An example application identifier could be “SAP S/4HANA” and version number could be “2023.” In operation 214, workload application identification data (“WL ID data”) 143 is discovered. In one example, workload application identification data is discovered by pushing the discover workload type extension 132 to the main application component (e.g., the VM 142). The discover workload type extension 132 runs on the main application component (e.g., the VM 142) and performs a set of operations to discover the application identity and version information, e.g., by reading configuration files, registry settings, etc., on (or accessible by) the VM 142. Based on this discovered information, the discover workload type extension 132 sends back the WL ID data 143 to the resource manager 122.

Once the WL ID data 143 is determined in operation 214, the WL ID data 143 is used in operation 216 to obtain automation data that is used to discover all application components for the particular workload deployment. In some examples, this is based on the recognition that every deployment of a particular workload application and version maintains information about itself-its metadata-which includes configuration information, in the same place and in the same way. With the knowledge of how this information is maintained by a particular workload application, automations can be executed to discover this information and all components associated with the workload application can be discovered. In some examples, additional automations are executed to identify the infrastructure resources upon which each workload component depends, and characteristics of these resources.

In other examples, alternative to, or in addition to, collecting infrastructure resource characteristic information from the workload deployment, infrastructure resource characteristics such as memory size and processor count of workload compute resources corresponding to vendor recommendations for best practices is retrieved from the workload database 136 and associated with workload components information. In some examples, this information is used as an “ideal” workload infrastructure resource dependency characteristic should a re-deployment or migration of a component be required as a result of a management action (described in more detail below with reference to operation 222), allowing for right-sizing workload infrastructure dependencies for the different workload components. Automations are retrieved and executed and the received data that associates components to each other and to the underlying infrastructure resources are gathered in operation 216.

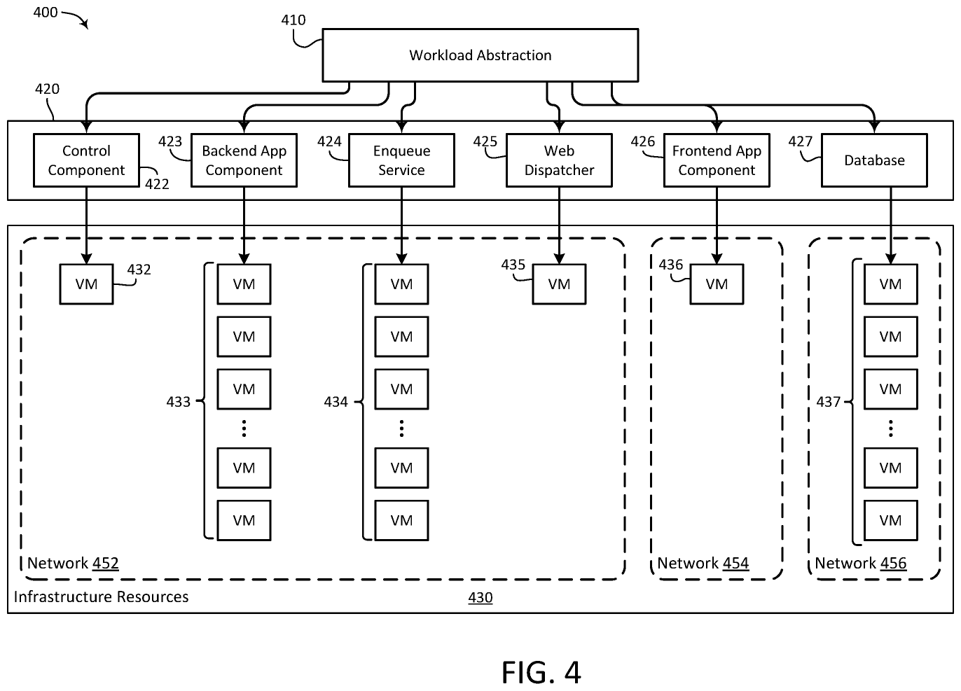

In operation 218, the relationship and infrastructure resource dependency information discovered in operation 216 is compiled into a hierarchical data structure, for example, in the form of a JSON file (or a file in some other data format). In some examples, this data structure is represented as a graph as illustrated in FIG. 4, which is described in further detail below.

In operation 220, the resource manager 122 generates a workload abstraction which is displayed in the form of an icon or text on user interface 115 in some examples. The workload abstraction represents all components and resources associated with the workload deployment, and the user 110 is able to perform management actions on the workload abstraction, which acts as a layer of indirection for the management actions. The resource manager 122 is therefore able to translate actions directed at the workload abstraction to all corresponding components and/or infrastructure resources that make up the workload deployment.

In operation 222, some management operation is applied to a workload abstraction as a single entity using the data structure created in operation 218. For example, for a management operation such as backup, the user 110 selects a particular workload abstraction and selects an operation such as “backup.” The workload abstraction then acts as a layer of indirection whereby the backup command is applied to all infrastructure resources listed in the hierarchical data structure. This example is further described below in reference to FIG. 4.

With reference now to FIG. 3, a flowchart 300 illustrating another exemplary process for discovering a workload on an infrastructure is provided. As with the process described above with reference to FIG. 2, the process illustrated in FIG. 3 is performed by the resource manager 122. However, in other examples, some other component of the management plane 120, or some stand-alone application performs the process without materially affecting the overall process. The process illustrated in FIG. 3 is implemented using machine readable and executable instructions encoded on some non-transitory data storage medium or media using one or more computer processors (not shown).

The process begins at start block 302 and proceeds with decision block 304 in which a determination is made as to whether the workload discovery will be systemic or user-initiated. For systemic discovery, the process proceeds to operation 306 in which an “identify workload” procedure is performed on all VMs (or other compute resources) in the datacenter region 140 or regions 145. For example, referring back to FIG. 1, in a cloud deployment, the identify workload type extension 134 is pushed to each of the VMs 142 and 144 in a customer's subscription. In operation 308, the identify workload type extension 134 provides VM IDs (or equivalent) of any infrastructure compute resource hosting a workload application and its main components, and the workload type (e.g., vendor name for the workload) thereof to the resource manager 122.

In some examples, when the workload discovery is to be user-initiated, the process flows from decision block 304 to operation 310 in which a workload type (e.g., vendor name for the workload) and the VM ID (or equivalent) is received from the user 110. In one example, the user 110 is aware of the physical location of the workload's main components but not all the components of the workload. In some examples, the user 110 is be presented with a list or depiction of VMs in their subscription and highlight or otherwise select a representation of the target VM (e.g., an icon) or otherwise indicate the VM containing the main components of the workload the user 110 wishes to discover, and then select the discover operation from a context-based menu or other means.

In operation 312, the workload type and VM ID provided in either operation 308 or operation 310 is used to discover application identification information in operation 312. As illustrated in FIG. 1, this may be done by pushing the discover workload type extension 132 to the main application component of the VM 142 in the datacenter region 140. In a physical environment, other techniques to run a script serving the same purpose can be employed. In some examples, the discover workload type extension 132 is specific to the type of workload (e.g., the vendor name) and understands how the workload stores information about all the components in the deployment. For example, the discover WL VME 132 accesses a particular configuration file and is capable of parsing the configuration file to determine each of the components and logical locations (e.g., IP addresses) for each of the components that make up the workload deployment. The exact method will depend on the workload type and how the workload stores configuration information.

In another example (not shown), operations 306, 308, and 312 are combined into a single step using a combined VME (not shown) that is deployed across all VMs in a user's subscription and identifies all major workload deployments, and the locations of the main components of each deployment. This can be done by providing the combined VME with a knowledgebase of a plurality of workload types, and, for each type, how to query the application identity information (e.g., application name and version number) for each type.

In operation 314, the application identification information is used as an index to the workload database 136 to retrieve workload-specific automations as described in detail above.

In operation 316, automations are executed as previously described to identify information regarding each workload component of the workload, including relationships therebetween, and information about infrastructure resource dependencies thereof. In this example, the automations are applied recursively. That is, after discovering information about a main component and all the subcomponents the main component is aware of, applying additional automations on each subcomponent to discover sub-sub components. In this way, a multi-level hierarchy of workload components, relationships, and infrastructure resource dependencies can be discovered. Whether automations are applied recursively may depend on the application identification information, where some types of applications may have muti-level hierarchical deployments and others not.

In operation 318, the information discovered in operation 316 is compiled into a virtual instance data structure, also referred to herein as a workload graph, described in detail above. In operation 319, the workload deployment is managed as a cohesive entity via the management plane. An example management operation will now be described with reference to FIG. 4.

FIG. 4 shows a high-level block view of a workload graph 400, which is a graphical representation of a set of data objects that represent application components and infrastructure resources and relationships therebetween for a workload deployment. Root node 410 (e.g., the workload abstraction) includes data (not shown) relevant to the root node 410 including its identity, and in some examples, includes a set of characteristics such as the workload type of the deployment, permissions, and so forth. A set of workload software component nodes 420 are connected by directed edges, represented by arrows extending from the root node 410 to each of the software component nodes 422-427. Each software component node in the set of workload software component nodes 420 is a data object that represents a software component of the workload deployment and may include data (not shown) describing information about the software component such as which other software components it communicates with and configuration information specific to the software component.

Although only one tier of software component nodes is shown in FIG. 4, in some examples, software components that do not relate directly to the root node 410, but instead are subcomponents of a particular component are provided. In these examples, there is another software component node with a directed edge (i.e., arrow) from the high level software component node to the subcomponent node. In the example shown in FIG. 4, the set of workload software component nodes 420 are all arranged in a single row and include control component node 422, back-end component node 423, enqueue service node 424, web dispatcher node 425, frontend application component node 426, and database node 427.

Each of the component nodes 422-427 relies on a set of infrastructure resources 430. For instance, the control component, represented by the control component node 422 runs on a VM represented by VM node 432, and the VM node 432 is within a network represented by network node 452 (illustrated as a dashed-line box around all VM nodes that run on the network to make the figure easier to understand). Likewise, a back-end component, represented by the back-end component node 423, resides on a set of VMs represented by VM nodes 433; a enqueue service component, represented by the enqueue service node 424, resides on a set of VMs represented by VM nodes 434; and a web dispatcher component, represented by the web dispatcher node 425, resides on a VM represented by VM node 435. In some example, all of the VMs (e.g., the VMs 432-435) reside on a network represented by network node 452.

Similarly, the frontend app component, represented by the frontend application component node 426, resides on a VM represented by VM node 436 and that VM resides on a network represented by network node 454. In addition, the database component, represented by the database node 427, resides on a set of VMs represented by VM nodes 437. In some examples, all of the VMs (e.g., the VM nodes 436 and 437) reside on a dedicated network represented by network node 456.

Each VM node includes information (not shown) about the VM, including the VM characteristics such as its identity, its “size” which relates to how much memory, processing, and networking resources are allocated to the VM, and subcomponents such as networking interfaces and their characteristics, and other add-on features if available, and example of which might be artificial intelligence (AI), graphics, or encryption coprocessors or add-ons. In addition, or as an alternative to actual VM size of deployed resources, infrastructure resource nodes 432-456 provide “best practice” information for that particular resource, according to vendor recommendations. This way, errors of overprovisioning of resources (for example, provisioning a virtual machine that is much more powerful than needed by the software component deployed onto that virtual machine) can be corrected when the software component on that virtual machine is migrated or upgraded onto different infrastructure components. In some examples, VM nodes include information about physical resources associated with the VM, including which physical host the VM is deployed on and characteristics of the physical host including its own size and networking information. In other examples, these physical host characteristics can be maintained in a physical infrastructure resource node (not shown) with yet another directed edge from the VM node to the physical infrastructure resource node corresponding to the physical host on which the VM resides.

While the example illustrated in FIG. 4 is directed to a workload deployment based on VMs, in some examples, a similar graph is constructed (not shown) for a workload deployment that is containerized, in which each infrastructure compute node can correspond to a container that runs a component or subcomponent of the workload. Likewise, a deployment directly on physical infrastructure can similarly be represented by such a graph.

In example, all the information maintained by the workload graph 400 is compiled into a single machine-readable data file, such as a JSON file, which is capable of storing and organizing hierarchical data in a human-readable format. In some examples, the workload graph 400 is stored in any number of formats, e.g., using another type of data format such as XML, or using a relational database to store a representation of the workload graph 400.

A discussion of an exemplary management operation on a workload as a whole is now be described with further reference to FIGS. 1 and 4. In this example, assume that the user 110 wishes to check the health of their entire workload deployment. In this case, the user 110 can access the user interface 115 and select an icon on the screen that represents a workload abstraction for the workload deployment, and then select an action such as “check health.” Other actions may include, for example, “back up,” “migrate,” “replicate” (e.g., for disaster recovery), “shut down/remove,” “track costs,” “monitor,” etc.

As explained above, the workload abstraction acts as a layer of indirection allowing for commands initiated against the abstraction to be redirected to components and resources of the workload deployment. In this case, the workload graph 400, which corresponds to the selected workload abstraction, functions as a map to those components and resources. Using existing techniques, health assessment is performed on each component and/or VM, network and storage resources mapped to the selected workload by the workload graph 400, and these health measurements are compiled into a single metric that is reported back to the user 110. The user can then, using the user interface 115, drill down into that health metric to identify specific components or infrastructure resources that may be affecting the performance of the workload.

In a similar manner other management operations are redirected to individual workload components so that the workload as a whole can be acted on using the workload graph 400 as a map to those additional resources, thus ensuring a reliable and correct execution of those management operations.

### Exemplary Operating Environment

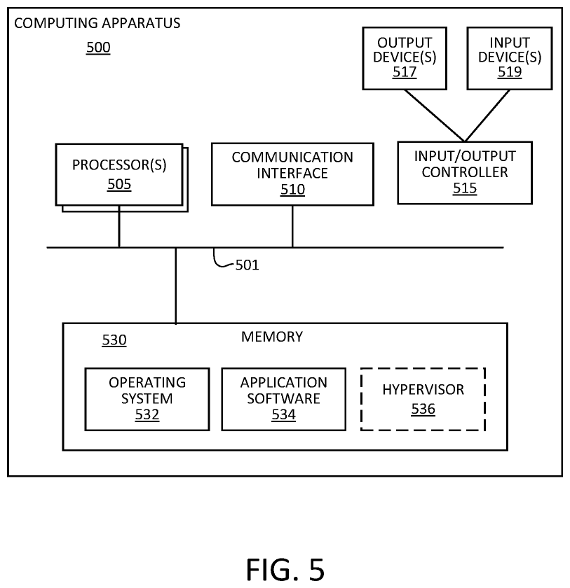

FIG. 5 is a functional block diagram illustrating by way of example a computing apparatus with which the technology described by the present disclosure is operable. Components of computing apparatus 500 are implemented as a part of an electronic device (e.g., an electronic device that either includes or is connected to user interface 115, resource manager 122, and/or VMs 142, 144). Computing apparatus 500 comprises one or more processors 505 which may be microprocessors, controllers, or any other suitable type of processors for processing computer executable instructions to control the operation of the electronic device. Alternatively, or in addition, the processor 505 is any technology capable of executing logic or instructions, such as a hard-coded machine. In some examples, platform software comprising an operating system 532 or hypervisor 536 or any other suitable platform software is provided on the computing apparatus 500 to enable application software 534 to be executed on the computing apparatus 500.

In some examples, computer executable instructions are provided using any computer-readable media that is accessible by the computing apparatus 500. Computer-readable media include, for example, computer storage media such as memory 530 and communications media (not shown). Computer storage media, such as the memory 530, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), or other optical storage, magnetic tape, or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not, and does not include, a propagating signal. Propagated signals are not examples of computer storage media. Although the computer storage medium (e.g., the memory 530) is shown within the computing apparatus 500, in some examples, the storage is distributed or located remotely and accessed via a network or other communication link (e.g., using communication interface 510).

Further, in some examples, the computing apparatus 500 comprises an input/output controller 515 configured to output information to one or more output devices 517, for example a display, printer, or a speaker, which are separate from or integral to the electronic device. Additionally, or alternatively, the input/output controller 515 is configured to receive and process an input from one or more input devices 519, for example, a keyboard, a microphone, or a touchpad. In one example, the output devices 517 also act as the input device. An example of such a device is a touch sensitive display. In some examples, a user provides input to the one or more input device(s) 519 and/or receives output from the output device(s) 517.

The functionality described herein can be performed, at least in part, by one or more hardware logic components. The computing apparatus 500 is configured by the program code when executed by the processor 505 to execute or perform described operations and functionality. Alternatively, or in addition thereto, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

The computing apparatus 500 may be a compute resource of an infrastructure for a datacenter region 140. If the infrastructure is cloud-based or otherwise virtualized, the computing apparatus 500 may be implemented as a virtual machine, which case the processors 505, the input/output controllers 515, the communication interface 510, and the memory 530 are virtualized and run on top of the hypervisor 536 of a corresponding host computing apparatus (e.g., the computing apparatus 500). The hypervisor 536 may function as system-level software on such a physical host. It is also possible for a virtual machine to execute on another virtual machine in a nested fashion. In virtualized infrastructures, the communication interface 510 is virtual and may be connected to a virtual switch running on the host computing apparatus. A virtual switch is a software implementation of a physical network switch. The host computing apparatus may reside as a rack-mounted server computer within a private cloud or large or even hyper-scaled data center.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

As used herein, the term “set” is non-empty, and may also be referred to as a “group”.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Below are specific example implementations offered here without limitation:

An example method of discovering a workload deployment comprises: obtaining workload application identification information for a workload deployment deployed in an infrastructure, the infrastructure comprising infrastructure resources including compute, networking, and storage infrastructure resources, the workload deployment comprising a plurality of workload components deployed across a plurality of the compute infrastructure resources, the workload application identification information comprising a workload application name and version reference associated with the workload deployment; querying a workload database using the workload application identification information; in response to the querying, obtaining a set of automations for discovering metadata corresponding to or associated with all of the workload components of the workload deployment, the metadata comprising information about each of the workload components and corresponding dependent infrastructure resources, the set of automations comprising at least one automation comprising executable code; executing the set of automations obtained from the workload database; obtaining, from the set of automations, the workload component and the dependent infrastructure resource metadata for all of the workload components, the metadata including, for each of the workload components, relationship information and compute resource identity information, the relationship information providing dependency information between workloads; compiling the workload component and the dependent infrastructure resource metadata for the workload deployment into a data structure; generating a workload abstraction corresponding to the data structure; and performing a management operation using the workload abstraction.

In an example, a set of machine-readable storage media comprises at least one machine-readable storage medium storing computer-executable instructions that, upon execution by one or more processors, cause the processors to perform a method for discovering a workload deployment, the method comprising: obtaining workload application identification information for a workload deployment deployed in an infrastructure, the infrastructure comprising infrastructure resources including compute infrastructure resources, the workload deployment comprising a plurality of workload components deployed across a plurality of the compute infrastructure resources, the workload application identification information comprising a workload application name and version reference associated with the workload deployment; obtaining a set of automations using the workload application identification information, the set of automations comprising at least one automation comprising executable code for discovering workload component and dependent infrastructure resource metadata corresponding to or associated with all of the workload components of the workload deployment; obtaining, from the set of automations, the workload component and the dependent infrastructure resource metadata for all of the workload components, the metadata including, for each of the workload components, relationship information and compute resource identity information, the relationship information providing dependency information between workload components, the compute resource identity information comprising compute resource identifiers and dependency information associating the compute resource identifiers with corresponding workload component identifiers; compiling the workload component and the dependent infrastructure resource metadata for the workload deployment into a data structure; generating a workload abstraction corresponding to the data structure; and performing a management operation using the workload abstraction.

In yet another example, a system comprises one or more processors and a set of machine-readable storage media comprising at least one machine-readable storage medium storing computer-executable instructions that, upon execution by the one or more processors, cause the processors to perform a method for discovering a workload deployment, the method comprising: obtaining workload application identification information for a workload deployment deployed in an infrastructure, the infrastructure comprising infrastructure resources including compute infrastructure resources, the workload deployment comprising a plurality of workload components deployed across a plurality of the compute infrastructure resources, the workload application identification information comprising a workload application name and version reference associated with the workload deployment; obtaining a set of automations using the workload application identification information, the set of automations comprising at least one automation comprising executable code for discovering workload component and dependent infrastructure resource metadata corresponding to or associated with all of the workload components of the workload deployment; obtaining, from the set of automations, the workload component and the dependent infrastructure resource metadata for all of the workload components, the metadata including, for each of the workload components, relationship information and compute resource identity information, the relationship information providing dependency information between workload components, the compute resource identity information comprising compute resource identifiers and dependency information associating the compute resource identifiers with corresponding workload component identifiers; compiling the workload component and the dependent infrastructure resource metadata for the workload deployment into a data structure; generating a workload abstraction corresponding to the data structure; and performing a management operation using the workload abstraction.

Alternatively, or in addition to the other examples described herein, examples include any combination of the following:
Wherein the compute resource is a virtual machine deployed in the infrastructure and the compute resource identity comprises a virtual machine identifier.
Wherein the obtaining of the workload application identification information comprises receiving workload type and the compute resource identity from a user interface.
Wherein the obtaining of the workload application identification information comprises receiving the workload application identification information from a discover workload agent deployed to a particular compute resource that hosts a main component of the workload deployment.
Wherein the compute resource hosting the main component of the workload deployment is identified by: deploying a plurality of identify-workload-type agent on a plurality of virtual machines in the infrastructure; and receiving a notification of the presence of the main component on the particular compute resource from one of the plurality of identify-workload-type agents that is deployed on the particular compute.
Wherein at least one automation the set of automations comprises executable code configured in a manner specific to the workload application identification information to discover all application components of the workload deployment.
Wherein at least one automation of the set of automations comprises executable code configured to identify dependent infrastructure resources for each of the application components of the workload deployment.
Wherein: a representation of the workload abstraction is presented to a user by a user interface that is generated by a management plane for the infrastructure; and the performing of the management operation is in response to an instruction received from the user via the user interface, the instruction being applied by the user to the workload abstraction; and the performing of the management operation is redirected, using the data structure, by the management plane to a set of the components of the workload deployment or a set of the infrastructure resources corresponding to ones of the components of the workload deployment.

Having described aspects of the disclosure in detail, it will be apparent that modifications and variations are possible without departing from the features set forth in the appended claims. As various changes could be made in the above constructions, products, and methods without departing from the scope of the claims, it is intended that all matter contained in the above description and shown in the accompanying drawings shall be interpreted as illustrative and not in a limiting sense.

What is claimed is:

1. A method of discovering a workload deployment, the method comprising:
obtaining workload application identification information for a workload deployment deployed in an infrastructure, the infrastructure comprising infrastructure resources comprising compute infrastructure resources, networking infrastructure resources, and storage infrastructure resources, the workload deployment comprising a plurality of workload components deployed across a plurality of the compute infrastructure resources, the workload application identification information comprising a workload application name and version reference associated with the workload deployment;
querying a workload database using the workload application identification information;
in response to the querying, obtaining a set of automations for discovering metadata corresponding to or associated with all of the workload components of the workload deployment, the metadata comprising information about each of the workload components and corresponding dependent infrastructure resources;
executing the set of automations obtained from the workload database;
obtaining, from the set of automations, workload component and dependent infrastructure resource metadata for all of the workload components, the workload component and dependent infrastructure resource metadata comprising, for each of the workload components, relationship information and compute resource identity information, the relationship information providing dependency information between workloads;
compiling the workload component and the dependent infrastructure resource metadata for the workload deployment into a data structure;
generating a workload abstraction corresponding to the data structure; and
performing a management operation using the workload abstraction.

2. The method of claim 1, wherein the compute infrastructure resources are virtual machines deployed in the infrastructure and the compute resource identity information comprises a virtual machine identifier.

3. The method of claim 1, wherein the obtaining of the workload application identification information comprises receiving a workload type and a compute resource identity from a user interface.

4. The method of claim 1, wherein the obtaining of the workload application identification information comprises receiving the workload application identification information from a discover workload agent deployed to a particular compute resource that hosts a main component of the workload deployment.

5. The method of claim 4, wherein the particular compute resource hosting the main component of the workload deployment is identified by:
deploying a plurality of identify-workload-type agents on a plurality of virtual machines in the infrastructure; and
receiving a notification of a presence of the main component on the particular compute resource from one of the plurality of identify-workload-type agents that is deployed on the particular compute resource.

6. The method of claim 1, wherein at least one automation in the set of automations comprises executable code configured in a manner specific to the workload application identification information to discover all application components of the workload deployment.

7. The method of claim 6, wherein at least one automation in the set of automations comprises executable code configured to identify dependent infrastructure resources for each of the application components of the workload deployment.

8. The method of claim 1, wherein:
a representation of the workload abstraction is presented to a user by a user interface that is generated by a management plane for the infrastructure;
the performing of the management operation is in response to an instruction received from the user via the user interface, the instruction being applied by the user to the workload abstraction; and
the performing of the management operation is redirected, using the data structure, by the management plane to a set of the workload components of the workload deployment or a set of the infrastructure resources corresponding to ones of the workload components of the workload deployment.

9. A computer-readable media comprising computer-executable instructions that, upon execution by a processor, cause the processor to perform a method for discovering a workload deployment, the method comprising:
obtaining workload application identification information for a workload deployment deployed in an infrastructure, the infrastructure comprising infrastructure resources comprising compute infrastructure resources, networking infrastructure resources, and storage infrastructure resources, the workload deployment comprising a plurality of workload components deployed across a plurality of the compute infrastructure resources, the workload application identification information comprising a workload application name and version reference associated with the workload deployment;
querying a workload database using the workload application identification information;
in response to the querying, obtaining a set of automations for discovering metadata corresponding to or associated with all of the workload components of the workload deployment, the metadata comprising information about each of the workload components and corresponding dependent infrastructure resources;
executing the set of automations obtained from the workload database;
obtaining, from the set of automations, workload component and dependent infrastructure resource metadata for all of the workload components, the workload component and dependent infrastructure resource metadata comprising, for each of the workload components, relationship information and compute resource identity information, the relationship information providing dependency information between workloads;
compiling the workload component and the dependent infrastructure resource metadata for the workload deployment into a data structure;
generating a workload abstraction corresponding to the data structure; and
performing a management operation using the workload abstraction.

10. The computer-readable media of claim 9, wherein:
a representation of the workload abstraction is presented to a user by a user interface that is generated by a management plane for the infrastructure;
the performing of the management operation is in response to an instruction received from the user via the user interface, the instruction being applied by the user to the workload abstraction; and
the performing of the management operation is redirected, using the data structure, by the management plane to a set of the workload components of the workload deployment or a set of the infrastructure resources corresponding to ones of the workload components of the workload deployment.

11. The computer-readable media of claim 9, wherein the obtaining of the workload application identification information comprises receiving the workload application identification information from a discover workload agent deployed to a particular compute resource that hosts a main component of the workload deployment.

12. The computer-readable media of claim 9, wherein at least one automation in the set of automations comprises executable code configured in a manner specific to the workload application identification information to discover all application components of the workload deployment.

13. The computer-readable media of claim 12, wherein at least one automation in the set of automations comprises executable code configured to identify dependent infrastructure resources for each of the application components of the workload deployment.

14. A system comprising:
a processor; and
a set of machine-readable storage media comprising at least one machine-readable storage medium storing computer-executable instructions that, upon execution by the one or more processors, cause the processors to perform a method for discovering a workload deployment, the method comprising:
obtaining workload application identification information for a workload deployment deployed in an infrastructure, the infrastructure comprising infrastructure resources comprising compute infrastructure resources, networking infrastructure resources, and storage infrastructure resources, the workload deployment comprising a plurality of workload components deployed across a plurality of the compute infrastructure resources, the workload application identification information comprising a workload application name and version reference associated with the workload deployment;
querying a workload database using the workload application identification information;
in response to the querying, obtaining a set of automations for discovering metadata corresponding to or associated with all of the workload components of the workload deployment, the metadata comprising information about each of the workload components and corresponding dependent infrastructure resources;
executing the set of automations obtained from the workload database;
obtaining, from the set of automations, workload component and dependent infrastructure resource metadata for all of the workload components, the workload component and dependent infrastructure resource metadata comprising, for each of the workload components, relationship information and compute resource identity information, the relationship information providing dependency information between workloads;
compiling the workload component and the dependent infrastructure resource metadata for the workload deployment into a data structure;
generating a workload abstraction corresponding to the data structure; and
performing a management operation using the workload abstraction.

15. The system of claim 14, wherein the compute infrastructure resources are virtual machines deployed in the infrastructure and the compute resource identity information comprises a virtual machine identifier.

16. The system of claim 14, wherein the obtaining of the workload application identification information comprises receiving a workload type and a compute resource identity from a user interface.

17. The system of claim 14, wherein the obtaining of the workload application identification information comprises receiving the workload application identification information from a discover workload agent deployed to a particular compute resource that hosts a main component of the workload deployment.

18. The system of claim 14, wherein at least one automation in the set of automations comprises executable code configured in a manner specific to the workload application identification information; and the set of automations, when executed, discover all application components of the workload deployment.

19. The system of claim 18, wherein at least one automation in the set of automations comprises executable code further configured to identify dependent infrastructure resources for each of the application components of the workload deployment.

20. The system of claim 14, wherein:
a representation of the workload abstraction is presented to a user by a user interface that is generated by a management plane for the infrastructure;
the performing of the management operation is in response to an instruction received from the user via the user interface, the instruction being applied by the user to the workload abstraction; and
the performing of the management operation is redirected, using the data structure, by the management plane to a set of the workload components of the workload deployment or a set of the infrastructure resources corresponding to ones of the workload components of the workload deployment.
